(19) United States
(12) Patent Application Publication
(10) Pub. No.: US 2016/0330761 A1
(43) Pub. Date: Nov. 10, 2016

(54) METHOD AND APPARATUS FOR CROSS-NODE SCHEDULING WITH NON-IDEAL BACKHAUL

(71) Applicants: ZTE WISTRON TELECOM AB, Kista (SE); ZTE (TX) INC., Austin, TX (US)

(72) Inventors: Patrick SVEDMAN, Kista (SE); Focai PENG, Kista (SE)

(21) Appl. No.: 15/109,054

(22) PCT Filed: Dec. 31, 2014
(86) PCT No.: PCT/US2014/072976

§ 371 Date: Jun. 29, 2016

Related U.S. Application Data
(60) Provisional application No. 61/923,078, filed on Jan. 2, 2014.

(51) Int. Cl. H04W 72/14; H04W 72/12; H04W 72/04

(52) U.S. Cl. CPC H04W 72/14; H04W 72/0426; H04W 72/1273

(57) ABSTRACT

A method and system for wireless communication system provide for transmitting a scheduling grant to a User Equipment (UE) and configuring the UE with a configurable time offset. The method and system also provide for transmitting a scheduling grant to a node and configuring the node with a configurable time offset. The UE transmits or receives a communication scheduled by said scheduling grant, and this transmitting or receiving a communication is delayed from said transmitting a scheduling grant by the configurable time offset. The configurable time offset may be an integer of multiple orthogonal frequency division multiplexing (OFDM) symbols in some embodiments and postpones or adjusts the UE transmitting or receiving a communication, with respect to a regular start time based on the scheduling grant. The method and system find application in cross-carrier and cross-node systems.

### RELATED APPLICATION(S)

This application is a 371 National Phase Application from International Application No. PCT/US2014/072976, filed Dec. 31, 2014 and claims benefit of priority under 35 U.S.C. §119(e) to Provisional Application 61/923,078 filed Jan. 2, 2014, entitled “Method and Apparatus for Cross-Node Scheduling with Non-Ideal Backhaul,” the contents of which are hereby expressly incorporated by reference as if set forth in their entirety.

### BACKGROUND

Wireless communication systems may have multiple carriers in the downlink (DL) and/or the uplink (UL) data transmissions. Furthermore, a user equipment (UE) may be capable of simultaneously receiving data transmissions on multiple DL carriers. This applies to various user equipment (UE) types including cellular telephones, pagers, wireless notepads, computers and various other mobile communication devices. A UE may also be capable of simultaneously transmitting on multiple UL carriers. The simultaneous transmission/reception on multiple carriers by a UE is often called carrier aggregation (CA), such as in Long Term Evolution (LTE) networks as described in Dahlman, Parkvall, Sköld, “4G LTE/LTE-Advanced for Mobile Broadband,” Academic Press, 2011, the contents of which are hereby incorporated by reference as if set forth in their entirety. The simultaneous transmission/reception on multiple carriers by a UE, where the carriers are handled by nodes that are connected with non-ideal backhaul, is one kind of dual connectivity such as may be used in future releases of LTE or other wireless communication systems. Backhaul may be described as the physical and/or logical communication link(s) between a node and other nodes, but also between a node and the core network and the internet. Physical backhaul links may be implemented using various communication technologies, using for example fiber, copper wire, microwave links, cellular wireless systems, etc, or a combination of multiple communication technologies, serially or in parallel or both.

In many wireless communication systems, the network controls the UE transmission and reception of data, at least to some extent, and this is referred to as scheduling or resource allocation. The network informs a UE of a scheduling decision by a grant, which is transmitted in the DL and received by the UE. A grant that informs a UE that it is to receive a DL data transmission is called a DL grant, and a grant that informs a UE that it is to transmit data in the UL is called a UL grant.

In many systems, DL grants are transmitted on the same carrier as where the corresponding DL data transmission occurs. For carrier aggregation (CA) UEs, however, a DL grant may be transmitted on a different carrier than the carrier through which the corresponding DL data transmission occurs. This is referred to as cross-carrier scheduling.

In Frequency Division Duplex (FDD) wireless systems, UL grants may be transmitted on a different carrier than the carrier in which the corresponding UL data transmission occurs. This is also a form of cross-carrier scheduling. In Time Division Duplex (TDD) systems, on the other hand, a UL grant is typically transmitted on the same carrier in which the corresponding UL transmission will occur. However, for carrier aggregation (CA) UEs in a TDD system, an UL grant may be transmitted on a different carrier than the carrier where the corresponding UL transmission occurs. This is also called cross-carrier scheduling.

Cross-carrier scheduling can also be used in mixed TDD-FDD systems, with TDD on some carriers and FDD on other carriers, according to the descriptions above or in other manners.

There may be a time delay between the transmission of a DL grant and the corresponding DL data transmission. Minimizing such a time delay may maintain link adaptation accuracy, since a DL grant often contains link adaptation information, such as which modulation and coding scheme should be used in the transmission. Therefore, DL grants are often transmitted simultaneously with, or immediately preceding, the corresponding DL data transmission. In LTE for example, DL grants may be transmitted immediately before the corresponding DL transmission (in case the DL grant is transmitted on physical downlink control channel (PDCCH)) or simultaneously with the DL transmission (in case the DL grant is transmitted on enhanced PDCCH (ePDCCH)).

For UL grants, there can be a time delay between the transmission and reception of an UL grant and the time instant the UE is expected to start the corresponding UL transmission enabling the UE to first receive and then decode the UL grant, and thereafter prepare the UL transmission.

The preceding time delays are fixed time delays.

In LTE FDD UL, the fixed time delay may be 4 subframes between UL scheduling grant in the DL and the corresponding UL transmission, for example. In LTE TDD UL, however, there may not be an UL subframe 4 subframes after the scheduling grant, depending on the TDD configuration and the DL subframe in which the grant was received so the fixed time delay of 4 subframes cannot be utilized. The TDD configuration may define which of the 10 subframes within a radio frame are used for DL transmission and which are used for UL transmission. Scheduling grants can be transmitted only in DL subframes. In some TDD configurations, the subframe that occurs 4 subframes after a UL scheduling grant in a DL subframe, is also a DL subframe, i.e. not a UL subframe. As such, in some examples such as some LTE systems, the time delay may include the UL scheduling grant referring to the next UL subframe instead of simply the next subframe but this time delay specified in the LTE protocol for LTE TDD and therefore fixed within the TDD configuration and not configurable.

In the LTE TDD configuration 0 example, there are more UL subframes (6) than DL subframes (4) within a radio frame but other configurations have at least as many DL subframes as UL subframes. This may result in the problem that, when UL scheduling grants are received, not all UL subframes can be scheduled for the corresponding UL transmissions within the radio frame. In this case, a 2-bit UL index may be introduced to the UL scheduling grants, only for LTE TDD configuration 0. This UL index is used to select and identify which (or both) out of two possible UL subframes that a UL scheduling grant refers to, i.e. the UL time index may be included in a UL scheduling grant that schedules a corresponding UL communication on a UL subframe identified/selected in the UL scheduling grant, by the UL time index. The 2-bit index may provide one-to-two mapping, since a UL scheduling grant in a specific subframe can schedule two different UL subframes, depending on the value of the UL index.

Traditional wireless communication systems may use a cellular topology using high-power macro base-stations. The trend in modern wireless communication systems, however, is towards heterogeneous networks (HetNet), in which a traditional cellular macro network is complemented with low-power nodes (LPNs). An LPN can for example be a femto, pico or micro base station, a remote radio head (RRH) or a relay node. The LPNs can be deployed for example where there is high traffic demand. The LPNs can communicate on the same carrier or carriers as the macro network, on a different carrier or carriers or on both the same and different carriers.

In many cellular system with macro base-stations, the base-stations operate rather independently. Some interaction between the base-stations is useful, such as handover of UEs between cells operated by different base-stations. The trend in modern wireless communication systems, however, is towards more coordination and interaction between nodes, where a node can be for example a macro base-station or an LPN. The coordination can for example be relatively fast, e.g. in the subframe level in LTE, or relatively slow, e.g., on the level of hundreds of milliseconds. Fast coordination may provide higher performance gains than slow coordination.

One factor in inter-node coordination is the backhaul with which the nodes are connected, including a node where a centralized coordination unit is located. If the backhaul has a long and/or jittery latency, it might be difficult to properly perform fast coordination. Such backhaul is often called non-ideal backhaul. Ideal backhaul has very low latency and high data rate. There is no generally accepted definition of ideal versus non-ideal backhaul or the point at which a deteriorating ideal backhaul becomes non-ideal backhaul. Ideal and non-ideal backhaul may generally be described as below for purposes of the present disclosure. The communication performance (latency, jitter, data rate etc.) between different units within a node, e.g. a base station, is typically considered ideal. Backhaul fulfilling the Common Public Radio Interface (CPRI) standard is usually classified as ideal. Originally, CPRI was used to inter-connect different units within a base station (e.g. baseband unit and radio unit). According to current trends, CPRI is also used to inter-connect units within different physically separated nodes, for example a centralized baseband unit in one node and a remote radio head in another node. In some cases, any backhaul with worse latency and/or throughput than some version of CPRI is considered a non-ideal backhaul. Stated according to another perspective, backhaul is considered ideal when the backhaul is not a limiting factor, to any significant degree, in any of the functions in the system. Stated alternatively, the ideal backhaul performance is sufficiently good such that improving the backhaul performance would not improve the system performance or functionality to a significant degree. Along the same lines, non-ideal backhaul in some way limits the performance or functionality. In some cases, backhaul latencies on the level of a few hundred microseconds or above are considered non-ideal. However, the distinction between ideal and non-ideal backhaul would typically depend on the system, protocols, requirements, and other relevant system factors.

Due to non-ideal backhaul deployments and other issues, improved methods and systems for transmitting and/or receiving data scheduled by a scheduling grant, are needed for cross-carrier and other systems.

### SUMMARY

In some wireless communication networks of the disclosure, cross-node scheduling is used whereby one node transmits a scheduling grant that schedules communication of another node with a UE. In some embodiments, the other node and/or the UE are informed of the scheduling decisions before they participate in the communication. Different nodes may need different times between receiving a scheduling decision and the start of a scheduled communication, depending on the node implementations. Different nodes may need different times between the time a scheduling decision is transmitted and the time it is received, depending on the way a node is informed, e.g. over non-ideal backhaul or air interface. Different time delays may therefore be required and are utilized for different nodes to receive the information according to the disclosure. Embodiments of the present disclosure address these objectives and provide a configurable time offset between the transmission/reception of a scheduling grant and the start of the corresponding scheduled transmission/reception for cross-node and other wireless communication systems.

### BRIEF DESCRIPTION OF THE DRAWING

The present disclosure is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and drawing.

FIG. 1 shows an embodiment of a wireless communication system;

FIG. 2 illustrates an embodiment of a wireless communication system that uses cross-carrier scheduling;

FIG. 3 illustrates an embodiment of a wireless communication system that uses cross-carrier scheduling;

FIG. 4 illustrates an embodiment of a wireless communication system that uses cross-node scheduling; and

FIG. 5 is a diagram illustrating the configurable time offset between transmission or receipt of a scheduling grant and the start of scheduled communication.

### DETAILED DESCRIPTION

In various wireless communication system embodiments of the disclosure, a network node receives a downlink transmitted by another network node. This may be referred to as network listening. One purpose of network listening is to obtain time and/or frequency synchronization from another node. Another purpose of network listening may be to allow the air interface to serve as a backhaul, such as in a relay in a Long Term Evolution (LTE) system. In an LTE relay, the user data and other communication with the core network is transferred over the air interface, to and from another network node that may have a dedicated connection to the core network. For an LTE relay, the scheduling and resource allocation of UEs served by the relay may be handled by the relay and therefore the scheduling decisions are not transferred over the air from a network node to the relay.

In some embodiments, such as for synchronization, the node listens to common signals/channels, i.e. signals/channels that are not dedicated to a specific receiver. In some implementations of wireless communication systems, such as for relays, the node listens to signals/channels that are dedicated to the node. In one sense, the node also acts as a UE.

The trend in modern wireless communication systems is towards more coordination and interaction between nodes which may be macro base-stations or LPNs. One way to implement more coordination between nodes is to have a centralized coordination unit that coordinates the nodes within an area. Another way to implement coordination is by a distributed algorithm that operates in parallel in multiple nodes in an area. In some embodiments, this coordination is relatively fast, e.g. in the subframe level in LTE, and in some embodiments the coordination is relatively slow, e.g., on the level of hundreds of milliseconds. Fast coordination may provide higher performance gains than slow coordination in some embodiments.

The present disclosure applies to various wireless communication systems including, but not limited to, those described above.

In some embodiments, the disclosure finds application in a network deployed with multiple carriers, wherein some nodes are not deployed with all carriers, and in which at least some nodes are connected with a non-ideal backhaul. This disclosure primarily considers backhaul links between nodes in the network. In some embodiments, the carriers are downlink carriers and in some embodiments, the carriers are uplink carriers. In some embodiments, the carriers are Time Division Duplex (TDD) carriers, i.e. both downlink and uplink on the same carrier. In some embodiments, the carriers are a mix of downlink, uplink and/or TDD carriers. In other embodiments, the disclosure finds application in various other networks and wireless communication systems.

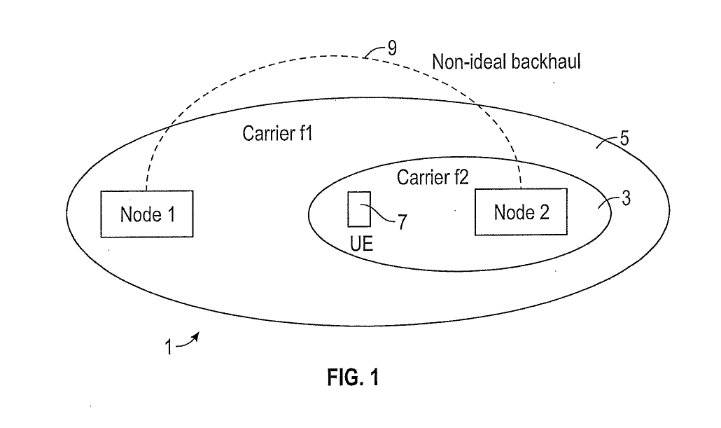

An embodiment of part of a wireless communication network is shown in FIG. 1. In FIG. 1, network 1 is arranged with multiple carriers including carriers f1 and f2. Network 1 is representative of various types of wireless communication systems including Long Term Evolution (LTE) and other systems and may include additional carriers in various embodiments.

Nodes 1 and 2 are not deployed with all carriers in the embodiment of FIG. 1. Node 1 is deployed with carrier f1 and Node 2 is deployed with carrier f2. The oval shapes of coverage areas 3 and 5 represent the coverage areas of the carriers f1 and f2. Coverage area 3 is covered by Node 2 on carrier f2 and also covered by Node 1 on carrier f1. Coverage area 5 is covered by Node 1 on carrier f1 in all locations and Node 2 on carrier f2 in some locations, i.e. coverage area 3 is within coverage area 5. In the embodiment of FIG. 1, Nodes 1 and 2 are connected with non-ideal backhaul 9, described above. UE 7 is in the coverage area 5 of Node 1 (on carrier f1) and also in the coverage area 3 of Node 2 (on carrier f2). UE 7 may represent a cellular telephone, pager, wireless notepad, tablet, computer or any of various other mobile communication devices.

In some embodiments, UE 7 is capable of carrier aggregation (CA), i.e. the simultaneous transmission and reception on multiple carriers. In FIG. 1, UE 7 supports carrier aggregation (CA) of carrier f1 and carrier f2. In some embodiments, UE 7 is in the coverage area of multiple additional carriers that it supports, including carriers in addition to carriers f1 and f2 shown in FIG. 1. In some system embodiments such as shown in FIG. 1, the coverage of UE 7 on different carriers is provided by different nodes that are connected with non-ideal backhauls. In FIG. 1, UE 7 is in both coverage area 5 of carrier f1 and coverage area 3 of carrier f2, but the coverage on different carriers is provided by different nodes, Node 1 and Node 2 connected by non-ideal backhaul 9.

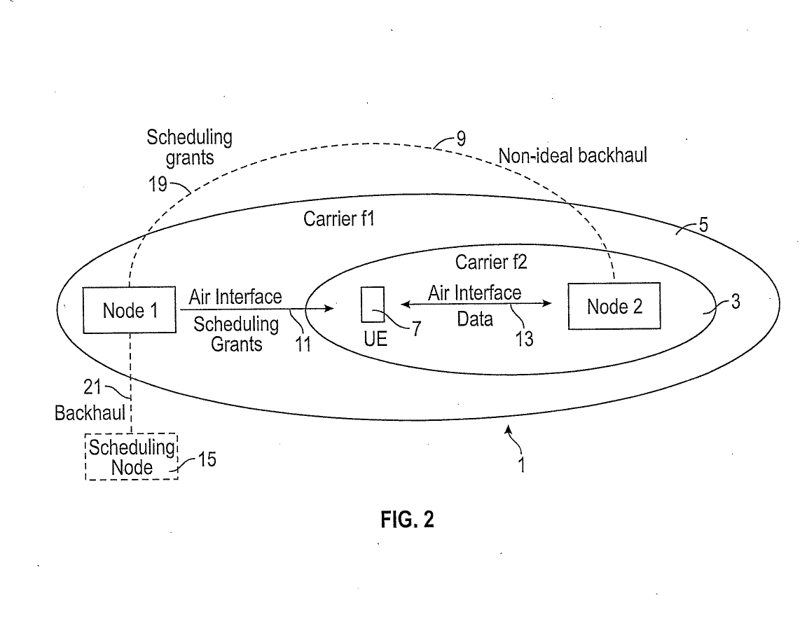

In some embodiments (as will be shown in FIG. 2), the disclosure provides for one node to serve as a scheduling node that advantageously schedules the transmissions/receptions of one or more other nodes which serve as slave nodes. When the transmissions/receptions of multiple slave nodes are scheduled by a scheduling node, this enables communications to be coordinated to reduce or eliminate interference, thereby improving performance.

In some embodiments, a slave node is informed of the scheduling grants concerning the UEs it serves. In some embodiments, the scheduling grants to the UE are transmitted by a scheduling node (such as Node 1 in FIG. 2) and received by a slave node (such as Node 2 in FIG. 2) that carries out a subsequent communication with the UE, as scheduled by the grant. In some embodiments, such scheduling grants are sent over a backhaul from the scheduling node to a slave node such as over backhaul 9 also shown in FIG. 2. In some embodiments, the scheduling grants are communicated between the scheduling node and a slave node over the air interface of the wireless communication system. In some embodiments, the scheduling grants are communicated between the scheduling node and a slave node first over a backhaul link between the scheduling node and another node and then over the air interface of the considered wireless communication system. In some embodiments, the air interface is an air interface in an LTE wireless communication system. In some embodiments, the scheduling grants to the UE that communicates with the slave nodes, are transmitted by another node than the scheduling node. In this case, the scheduling grants may transferred from the scheduling node to the node that transmits them, for example over a backhaul link. In one embodiment, the scheduling grants to the UE scheduled to communicate with the slave nodes are transmitted on another carrier using cross-carrier scheduling. FIG. 2 shows various of the previously described aspects by way of addition of features to the system shown in FIG. 1.

In FIG. 2, the scheduling of data transmissions 13 between Node 2 and UE 7 on carrier f2 is performed by a scheduling node. Scheduling grants 11 scheduling communication between UE 7 and the slave node (Node 2) are generated by the scheduling node and received by UE 7 and the slave node (Node 2). The scheduling node may be located in Node 1 in some embodiments or the scheduling node may be located in a separate node connected with Node 1 with a backhaul 21, such as scheduling node 15 (shown in dashed lines) which transmits scheduling grants to Node 1 over backhaul 21. In some embodiments, the scheduling grant 11 to UE 7 which carries out a corresponding subsequent scheduled communication with the slave node (Node 2), is transmitted by another node (Node 1) than the scheduling node (scheduling node 15). In the embodiment of FIG. 2, the scheduling grants 11 for the data transmissions 13 between UE 7 and Node 2 on carrier f2 are transmitted by Node 1 using cross-carrier scheduling. Scheduling grants 11 are transmitted by Node 1 over the air interface on carrier f1 and received by UE 7 on carrier f1. This embodiment uses cross-carrier scheduling because the scheduling grant 11 to UE 7 scheduled to communicate with the slave node (Node 2), is received on carrier f1 while the corresponding data transmission 13 occurs on the scheduled carrier (carrier f2). The same, or a different scheduling grant 19 is sent to Node 2 over the non-ideal backhaul 9. The scheduling grants which may be the same or different scheduling grants, are generally the same and include the same key information sent to both Node 2 and UE 7. The key information includes information necessary to participate in the scheduled communication such as but not limited to time and frequency allocation, modulation and coding scheme, precoding and other transmission parameters.

In an embodiment in which scheduling grants 19 are sent to a slave node (Node 2) over non-ideal backhaul 9, the scheduling may be made well in advance before the corresponding scheduled transmissions should occur, so that the slave node (Node 2) receives the scheduling grants in time to carry out the subsequent communication. Scheduling in advance may have several drawbacks if the time lag is significant, however, since the scheduling cannot take into account the situation at the time of transmission or just prior to the transmission. Several aspects can change significantly between the time of scheduling and the corresponding later transmission, for instance radio channel properties (e.g. fading) and data buffer statuses, e.g. packet arrivals and other factors. The disclosure therefore advantageously provides for a scheduling decision to be made as close before the transmission as possible, based on the specific backhaul conditions, instead of well in advance of transmission for improved performance.

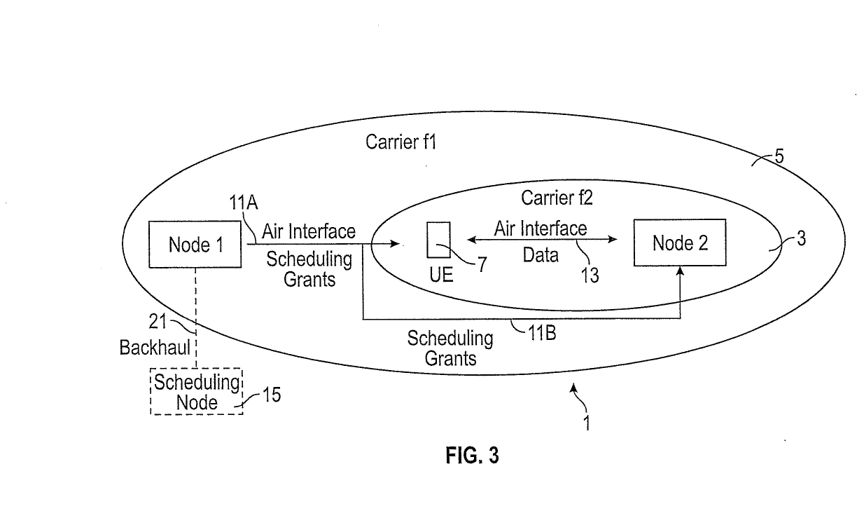

In some embodiments, such as shown in FIG. 3, the scheduling grants 11A, 11B are communicated between the scheduling node (Node 1) or from scheduling Node 15, and UE 7. The scheduling grants 11A, 11B are also communicated between the scheduling node (Node 1) or scheduling Node 15, and slave node (Node 2) over the air interface of the wireless communication system, for example over LTE. (Note that “scheduling grants 11A, 11B” are the same grant, a transmission sent by Node 1 and received by UE 7 and Node 2, and are referred to individually using multiple reference numbers, for ease of description only.) FIG. 3 illustrates cross-node scheduling, i.e. a scheduling grant specifying UE communications with one node and transmitted by another node. This cross-node scheduling can be seen as a form of network listening and may be helpful if the scheduling grant otherwise would have had to been sent over a non-ideal backhaul such as non-ideal backhaul 19 of FIG. 2. By avoiding scheduling grant transmission over non-ideal backhauls and using the air interface instead, the present disclosure provides that delay between scheduling and transmission can be reduced. Furthermore, the delay of a non-ideal backhaul may be jittery and unpredictable, whereas the delay of an air interface may be more predictable and constant over time.

In various embodiments, a slave node (Node 2) receives and decodes a scheduling grant 11 B over the air interface, e.g. LTE, that is also intended for and sent to UE 7 such as shown in FIG. 3. This represents an efficient use of air interface resources, since the scheduling grant 11A is being transmitted to UE 7. In the cross-node scheduling embodiment of FIG. 3, a slave node (Node 2) may receive scheduling information about transmissions to and/or from the slave node on a PDCCH or an ePDCCH, when the embodiment of FIG. 3 is an LTE network. These channels are used to carry downlink and uplink scheduling grants in LTE as above. In some embodiments in which cross-carrier scheduling is used and the scheduling grant is transmitted on a carrier other than the channel the slave node uses for communication with UEs, the slave node can receive signals also on the carrier where the scheduling grant is transmitted. This is shown in FIG. 3, in which Node 2 is the slave node that also receives the scheduling grants 11B that are transmitted over the air interface by Node 1 on carrier f1 and received by UE 7. In FIG. 3, regular cross-carrier scheduling grants 11A, 11B are transmitted by Node 1 on carrier f1 to UE 7. The scheduling grants 11A, 11B refer to communication on carrier f2, in particular data transmission 13 between the slave node (node 2) and UE 7. In FIG. 3, Node 2 obtains knowledge of the scheduling decision by also receiving the same scheduling grants 11 B on carrier f1 that UE 7 receives as scheduling grants 11A.

A scheduling grant specifying UE communications with one node and which is transmitted by another node, is referred to as cross-node scheduling and FIG. 3 illustrates a cross-node scheduling embodiment in which cross-node scheduling is performed using cross-carrier scheduling.

In another network architecture, cross-node scheduling is performed on a single carrier, i.e. cross-carrier scheduling is not used, and the UE receives a scheduling grant from one node on a carrier frequency, where the grant schedules UE communication with another node (a slave node) on the same carrier frequency as is used for the scheduling grant transmission.

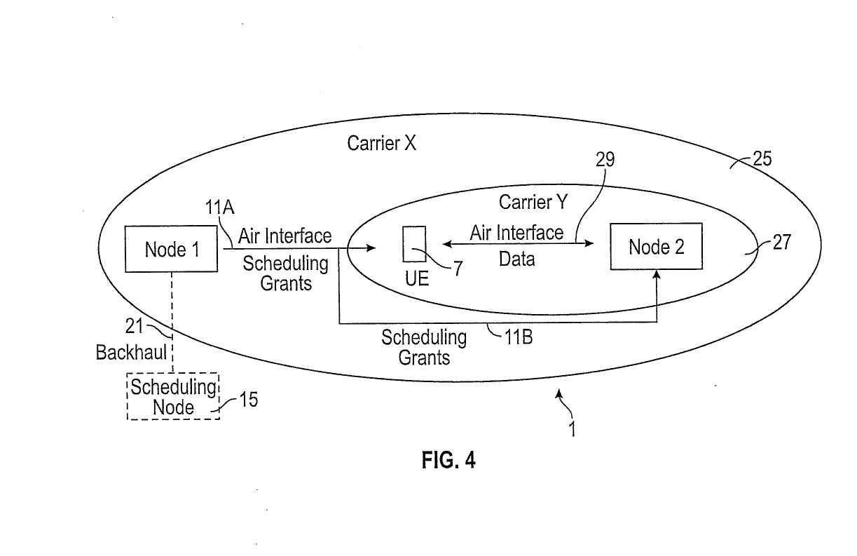

FIG. 4 covers both cross-node scheduling embodiments performed on a single carrier and cross-node scheduling embodiments performed using cross-carrier scheduling.

In some cross-node scheduling embodiments performed on a single carrier as will be described in conjunction with FIG. 4, a scheduling grant is transmitted by a node and received and successfully decoded by the UE. The grant schedules UE communication with another node, the slave node. The slave node also receives knowledge of the scheduling decision reflected in the scheduling grant and decodes the scheduling grant that is also received and decoded by a UE that it is meant for, on the same carrier that the scheduling grant refers to. In some embodiments, this is achieved by enabling the slave node to halt transmission during some time instants and/or frequencies, so that a signal carrying a scheduling grant can be received and successfully decoded. The scheduling is performed in the node that transmitted a grant or by another node, in various embodiments. The scheduling grant may be transmitted on a different carrier than it schedules or it may be transmitted on the same carrier that it schedules.

FIG. 4 presents a system arrangement using cross-node scheduling as referred to above. When cross-node scheduling is used, the scheduling and transmission of scheduling grant 11A, 11B is done by Node 1, not by the slave node, Node 2 that performs the scheduled data communication 29 with UE 7.

FIG. 4 is similar to FIG. 3 with the exception being that the two carriers are represented as “carrier x” and “carrier y” with respective coverage areas 25, 27. In cross-node scheduling embodiments performed on a single carrier, carrier x is the same as carrier y and in and cross-node scheduling embodiments performed using cross-carrier scheduling, carrier x is not the same as carrier y. Node 1 transmits a scheduling grant identified as scheduling grant 11A, 11B, above. Scheduling grant 11A is received by UE 7 and scheduling grant 11B is received by Node 2. Scheduling grant 11A, 11B schedules communication 29 between UE 7 and Node 2, the slave node. The communication may be a DL or UL communication. Scheduling grant 11A, 11B is transmitted on carrier x and refers to a scheduled communication on carrier y. Node 2 obtains knowledge of the scheduling decision by also receiving the same scheduling grant 11 B. The scheduling may be performed in the node that transmitted a grant or by another node. In some embodiments, the scheduling grants to UE 7 that is served by the slave node (Node 2) are transmitted by another node, e.g. (Node 1), than the scheduling node (e.g. scheduling node 15).

When cross-node scheduling is used, the scheduling and transmission of scheduling grant 11A, 11B is done by Node 1, not by Node 2 which is the slave node that performs the scheduled data communication 29 with UE 7.

There are several embodiments of cross-node scheduling, some of which are discussed above. A slave node (Node 2) may be informed of a scheduling decision over a backhaul, which may be non-ideal such as non-ideal backhaul 9 shown in FIG. 2, or over an air interface such as scheduling grant 11 shown in FIG. 3, and the air interface may be the same air interface that is used for UE communication.

There is often a fixed time delay between a transmission and/or reception of a grant and the corresponding data transmission and this fixed time delay is usually specified in a standardized protocol. In some embodiments such as DL grants in LTE, for example, the time delay is zero between DL scheduling grant transmission and corresponding DL data transmission. In some embodiments such as for UL grants in LTE FDD, as one example, the fixed time delay may be about 4 ms between UL grant reception and corresponding UL transmission but other fixed time delays are used in other embodiments.

In some cases, the fixed time delay is not sufficient between the instant a slave node (e.g. Node 2) receives a scheduling grant (e.g. scheduling grant 11B) and the time instant the slave node should perform the corresponding communication 29 with UE 7, again referring to FIG. 4.

A fixed time delay is typically specified for a mode of communication such as UL, DL, FDD and/or TDD as some examples, in a standardized protocol, such as LTE, and it is therefore valid for all corresponding communication using the standardized protocol. In LTE for example, there is one fixed time delay for FDD UL and another fixed time delay for FDD DL. A time delay that is fixed is not configurable within its mode and is not individualized for individual grants and corresponding communications. This disclosure provides for a configurable time offset that can be used to adjust the time delay between a particular transmission and/or reception of a scheduling grant and the corresponding scheduled data transmission. The configurable time offset of the disclosure is distinguished from the fixed time delay that cannot be adapted or configured. With a configurable time delay, the time delay between scheduling decision and corresponding transmission can be kept to a minimum. Furthermore, a configurable time offset makes it possible to schedule communication with slave nodes that could not have been scheduled at all with a fixed time delay, due to the latency of the non-ideal backhaul used to send the scheduling grant to the slave node.

The configurable time offset of the disclosure is also distinguished from the UL index included in UL scheduling grants for the LTE TDD configuration 0 only, as described above. The UL index is limited to selecting/identifying an UL subframe for transmission of a communication scheduled by a scheduling grant, in LTE TDD configuration 0 examples, and is not a configurable time offset. The configurable time offset of the disclosure is different than this UL index as the configurable time offset of the disclosure goes a step further and addresses the problem of cross-node scheduling with non-ideal backhaul, and provides a configurable time offset with a broad range and which is applicable to various wireless communication systems and UL and DL communications. The UL index does not address these concerns and only identifies one or a fixed number of subframes depending on the TDD configuration. The configurable time offset of the disclosure has a different scope because it provides a means to both reduce and increase the time offset to suit the particular conditions, in terms of backhaul delay etc., i.e. it is a configurable time offset and is applicable to TDD DL, FDD UL and FDD DL communication. In some embodiments, the configurable time offset of the disclosure may be used in combination with the UL index which is used to select/identify an UL subframe for transmission in LTE TDD configuration 0. In some embodiments, the scheduling grant such as scheduling grant 11 and 11A in FIGS. 2-4, may include the UL index. In some embodiments, the configurable time offset of the disclosure increases the time between UL scheduling grant and corresponding UL transmission by multiples of 1 radio frame (which equals 10 subframes and 10 ms).

For DL grants, a slave node advantageously first receives and decodes the scheduling grant. In some embodiments, the DL data transmission may also require some further preparation time, i.e. the DL data transmission may benefit from additional time to be prepared. For UL grants, a slave node receives and decodes the scheduling grant, then the UL receiver should be turned on or configured to receive the corresponding UL transmission.

In LTE and other systems, the disclosure provides for sufficient time between the reception of a DL scheduling grant and the start of the scheduled DL transmission, in order to implement and utilize a scheme whereby a slave node receives a DL grant over the LTE air interface or other backhaul. For LTE UL communications, a sufficient time between the reception of an UL grant and the start of the scheduled UL transmission is provided and enables the implementation of a scheme in which a slave node receives an UL grant over the LTE air interface or other backhaul. The method and system of the present disclosure provide such time offsets. In order to achieve the time offsets described above, embodiments of the disclosure provide a configurable time delay between the transmission and/or reception of a scheduling grant and the corresponding scheduled data transmission and/or reception.

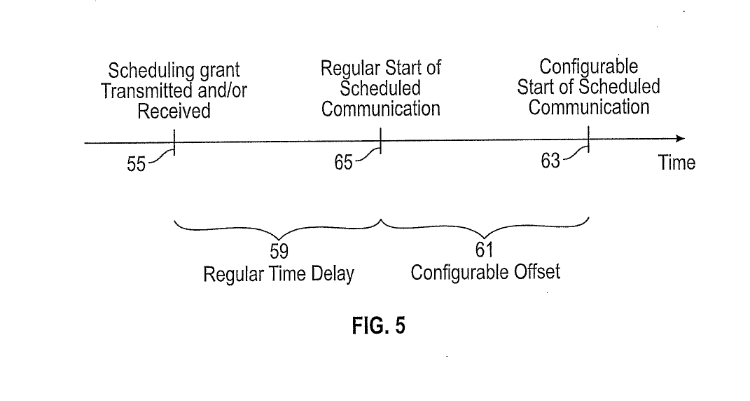

An embodiment of such a configurable time delay offset is illustrated in FIG. 5.

In various system embodiments, the fixed known time delay between a scheduling grant transmission/reception and the start of the corresponding scheduled transmission, discussed above, establishes or is included in “regular time delay” 59 in FIG. 5 and applies to all communications of a certain mode in a standardized protocol, for example UL FDD, as described above. In some UL systems, for example Long Term Evolution UL systems, this regular time delay 59 provides a time delay between the reception of an UL grant and the scheduled start of the corresponding transmission. The purpose of such fixed time delays is to provide a reasonable time delay between scheduling grant and corresponding transmission, to provide sufficient time for grant reception, decoding and communication preparation.

The present invention provides a configurable time offset distinguished from the fixed time delay, i.e. distinguished from the fixed time delay of “regular time delay” 59 of FIG. 5. The configurable time offset of the present invention goes a step further and the offset enables a slave node enough time between the reception of a scheduling grant and the start of communication. In some embodiments, the configurable time offset of the present disclosure is many microseconds such as 100-10000 milliseconds, but other time offsets are used in other embodiments. This time offset is shown as configurable offset 61 shown in FIG. 5.

Configurable time offset 61 is distinguished from offsets in LTE systems such as UL time advance. Configurable time offset 61 serves a completely different function and has a completely different time scale than UL time advance. For example, the configurable time offset of the disclosure is much larger than the UL time advance in LTE. For example, the UL time advance is sent to only UEs to adjust their UL transmission time, not to nodes. Configurable time offset 61 applies to both UL and DL communications whereas UL time advance only relates to the uplink.

Regarding the UL time advance, the different UL signals transmitted from different UEs should arrive simultaneously at the receiving node. Since the propagation delay, i.e. basically the distance between the UE and the node, differs between different UEs, their individual UL transmission timings may be adjusted by individual (configurable) UL time advance commands. A reference UL timing, to which time advance is added/subtracted, may be extracted from the received DL signal at the UE. Different UEs simultaneously transmitting UL to the same node typically have different UL time advances, since they have different propagation delays. The time advance differences between different UEs transmitting to the same node depends on the difference in propagation distance, but is typically a few microseconds or less. The time advance is typically measured in number of samples or chips or the smallest time unit for a system and may depend on system bandwidth.

In contrast, the configurable time offset 61 according to various embodiments of the present disclosure represents a delay between the transmission/reception of an UL grant to a UE and the time the corresponding transmission/reception starts. This configurable time offset 61 provides assurance that the node receiving the scheduling grant and communicating with the UL (the slave node in previous figures) has just enough time to receive and decode the scheduling grant and to prepare for the UL transmission(s). For this kind of delay, different UEs simultaneously scheduled for UL transmission to the same node typically are configured with the same time offset, since they all wait for the same node to be prepared to receive and this distinguishes the configurable time offset 61 from UL time advance, for example. Configurable time offset 61 of the disclosure provides a time delay that relates to the backhaul delay, grant decoding time and reception preparation. It may typically range from tens of microseconds up to tens of milliseconds. Configurable time offset 61 may be measured in number of transmission time intervals (TTIs), slots, subframes, frames or symbols, or in other suitable measurements. Configurable time offset 61 of the disclosure may be derived based on an estimate of a latency of a backhaul used to communicate a scheduling grant and an estimate of a time required to decode the scheduling grant and prepare for the UE to transmit or receive a communication, in order to provide a time delay necessary to for such communication.

In some embodiments, the two time offsets—the non-configurable UL time advance and configurable time offset 61—can be added together in the UE, such that the time alignment part (UL time advance) is used to align the signals from multiple UEs at the receiver side, whereas the configurable time offset of the disclosure is used to delay the transmission from all those UEs until the receiving node is ready to receive.

In FIG. 5, configurable time offset 61 is added to regular time delay 59 between scheduling grant 55 and corresponding communication, i.e. the configurable start of scheduled communication 63. Regular time delay 59 may be based on the fixed time delay as specified by the communication standard used for transmission. Regular time delay 59 may also include a UL or other time advance offset as discussed above. In some LTE TDD configuration 0 embodiments, configurable time offset 61 is used in conjunction with the UL index which may be used to determine regular start time 65. Without the configurable time offset 61, the regular start time 65 (regular start of scheduled communications which may be UL or DL communications in various embodiments) is offset from scheduling grant 55 only by regular time delay 59.

The configurable time offset 61 is transmitted to the UE and/or the slave node in various manners as described below. With the provision of the configurable time offset 61, a slave node will have enough time to first properly receive the scheduling grant, e.g. over a non-ideal backhaul or over the air interface, and secondly prepare the communication. In various DL embodiments in which extra time is needed, a slave node generally requires more time than regular time delay 59 offers, since the delay is often very small and the slave node needs to prepare the DL transmission, including coding, interleaving, modulation, filtering, conversion from baseband to intermediate frequency or radio frequency, digital to analog conversion, and the like. The configurable time offset 61 provides this additional time.

In various embodiments, the extent of configurable time offset 61 is determined by estimating the latency of the backhaul used to communicate the scheduling grant, and additionally estimating the time required to decode the grant and prepare for data transmission and/or reception. In some embodiments the two estimates are combined to derive configurable time offset 61. In various embodiments, the extent of configurable time offset 61 is determined and adapted based on historical reports of when the configurable time offset was insufficient, resulting in a communication outage, and when the configurable time offset was sufficient. Configurable time offset 61 is determined in various other manners in various embodiments and is added to the regular starting time of scheduled communication. The UE is informed of the configurable time offset by the network, over the air interface. The UE may be informed of the configurable time offset 61 by various nodes of the network in various embodiments. In some embodiments, the slave node may decide the configurable time offset 61 and inform the other nodes, and in other embodiments, the scheduling node determines the configurable time offset 61 and inform the other nodes, etc. In other embodiments, other network nodes determine the configurable time offset 61 and informs the other network nodes and the UE.

In various LTE embodiments, the configurable time offset 61 is in multiple subframes, so that a scheduled transmission is postponed an integer number of subframes, with respect to the regular start time 65. The integer may be positive or negative. In various embodiments, the configurable time offset 61 is an integer representing a plurality of subframes. In various embodiments, the configurable time offset 61 is measured in number of transmission time intervals (TTIs), slots, subframes, frames or symbols. In some LTE embodiments, the configurable time offset 61 is in multiple orthogonal frequency division multiplexing (OFDM) symbols. In one embodiment, if the network is configured with a control format indicator (CFI) that equals “X” (with “X” for example being 1, 2 or 3), then the regular start 65 of scheduled DL communication using physical downlink shared channel (PDSCH) is at OFDM symbol X+1 in the same subframe that the DL grant was received.

In one embodiment, if CFI=1, then the regular start time 65 of a scheduled transmission is in the subsequent symbol, i.e. the second symbol in the subframe, i.e. the symbol that immediately follows the scheduling grant. According to various embodiments of the disclosure, however, the regular start 65 of the scheduled DL communication is postponed an integer number of OFDM symbols and scheduled communication takes place at configurable start of scheduled communication 63, not regular start time 65. Using the disclosed system and method, the transmission can be started later than the regular start time 65, for example in the fourth symbol in the subframe and at configurable start of scheduled communication 63 but other integer numbers of subframes, i.e., multiple subframes are used for configurable time offset 61 is other embodiments. In other words, the configurable time offset 61 results in a start of scheduled communication later than the OFDM symbol that immediately follows the OFDM symbol that is the first symbol of the subframe, which carries the scheduling grant.

By offsetting the time delay to configurable start of scheduled communication 63, the disclosure enables the slave node to first receive the scheduling grant at 55, and then to prepare the transmission before the transmission should start. In various embodiments, there is a regular start time associated with the transmission of the scheduling grant and the configurable time offset 61 postpones the UE's transmitting or receiving the scheduled communication.

In various LTE and other embodiments, the configurable time offset 61 is represented by a negative integer or other value. In this embodiment, the configurable time offset causes the UE to transmit or receive the communication before regular start time 65. In this embodiment (not shown in FIG. 5), configurable start of scheduled communication 63 takes place before the regular start time 65 when the configurable time offset 61 is a negative value.

In various embodiments, the disclosure provides a network that configures a UE with an additional offset between transmission and/or reception of scheduling grant and scheduled transmission and/or reception. The offset is referred to as an “additional offset” because the configurable time offset is a time offset in addition to a regular or fixed time delay such as regular time delay 59 in FIG. 5.

In some embodiments, the disclosure provides a network that configures a UE for multiple transmissions over hundreds of milliseconds or other time frames, with an additional offset between transmission and/or reception of scheduling grant and scheduled transmission and/or reception for each of the multiple transmissions.

In some embodiments, the disclosure provides an LTE network and the LTE network configures the UE with an additional offset between transmission and/or reception of scheduling grant and scheduled transmission and/or reception using radio resource control (RRC) signaling. In other LTE networks, other means are used for configuring the UE with the additional offset between transmission and/or reception of scheduling grant and scheduled transmission and/or reception.

In some embodiments, the disclosure provides a network that configures a UE for a single grant with an additional offset between transmission and/or reception of the single scheduling grant and scheduled transmission and/or reception. In some embodiments, a network configures a UE with an additional offset between transmission and/or reception of scheduling grant and scheduled transmission and/or reception by including the offset in the scheduling grant transmitted to the UE, or in another scheduling grant.

In some embodiments, the configurable offset is not included in the scheduling grant itself. Instead, the UE and slave node are configured with the configurable time offset such that the configured offset is valid until reconfigured (such as the LTE RRC configuration example earlier), i.e. a configuration is valid for a plurality of subsequent scheduling grants. In some embodiments, the configurable time offset is not included in the scheduling grant itself and the UE is configured with the configurable time offset for a plurality of subsequent scheduling grants. In some embodiments, the UE is reconfigured with a different configurable time offset after the plurality of subsequent scheduling grants.

In some embodiments of the disclosure, an LTE network configures a UE with an additional offset between transmission and/or reception of scheduling grant and scheduled transmission and/or reception by including the offset in a Downlink Control Information (DCI).

In some embodiments, the disclosure provides a network node (e.g. Node 1 or Node 2, discussed above) that configures another network node (e.g. the other of Node 1 or Node 2, above) with an additional offset between transmission and/or reception of scheduling grant and scheduled transmission and/or reception. In various embodiments, this may be in addition to the network configuring the UE with the additional time offset. In some embodiments, the disclosure provides a network node that configures both the UE and another network node with the additional offset between transmission and/or reception of scheduling grant and scheduled transmission and/or reception.

In some embodiments of the disclosure, a network node requests another network node to use a specific or a range of additional offsets between transmission and/or reception of scheduling grant and scheduled transmission and/or reception. In some embodiments, the request is made by a slave node such as Node 2 in FIGS. 1-4 to a node that transmits scheduling grants e.g. a scheduling node, such as Node 1 or scheduling node 15 in FIGS. 1-4. In some embodiments, the request is made by a node that performs scheduling, e.g. a scheduling node (such as Node 1 or scheduling node 15 in FIGS. 1-4), to a slave node such as Node 2 in FIGS. 1-4. In some embodiments of the disclosure, the request is made by a node that transmits scheduling grants (such as Node 1 or scheduling node 15 in FIGS. 1-4), to a slave node such as Node 2 in FIGS. 1-4.

The word “exemplary” is used herein to mean “serving as an example or illustration.” Any aspect or design described herein as “exemplary” is not necessarily to be construed as preferred or advantageous over other aspects or designs.

The preceding merely illustrates the principles of the disclosure. It will thus be appreciated that those of ordinary skill in the art will be able to devise various arrangements which, although not explicitly described or shown herein, embody the principles of the disclosure and are included within its spirit and scope. Furthermore, all examples and conditional language recited herein are principally intended expressly to be only for pedagogical purposes and to aid the reader in understanding the principles of the disclosure and the concepts contributed by the inventors to furthering the art, and are to be construed as being without limitation to such specifically recited examples and conditions.

While one or more embodiments of the invention have been described above, it should be understood that they have been presented by way of example only, and not by way of limitation. Likewise, the various figures or diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations.

One or more of the functions described in this document may be performed by an appropriately configured module. The term “module” as used herein, can refer to hardware, firmware, software and any associated hardware that executes the software, and any combination of these elements for performing the associated functions described herein. Additionally, various modules can be discrete modules; however, as would be apparent to one of ordinary skill in the art, two or more modules may be combined to form a single module that performs the associated functions according various embodiments of the invention.

Additionally, one or more of the functions described in this document may be performed by means of computer program code that is stored in a “computer program product”, “non-transitory computer-readable medium”, “non-transitory computer-readable storage medium”, and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

What is claimed is:

1. A method in a wireless communication system, said method comprising:
transmitting a scheduling grant to a User Equipment (UE);
configuring said UE with a configurable time offset; and
said UE transmitting or receiving a communication scheduled by said scheduling grant,
said UE transmitting or receiving said communication delayed from said transmitting a scheduling grant by at least said configurable time offset,
wherein said wireless communication system is a cross-node system, said transmitting a scheduling grant is carried out by a first node and said UE transmitting or receiving a communication comprises said communication being with a second node, said first and second nodes being different nodes.

2. The method as in claim 1, wherein said configuring further comprises configuring said second node with said configurable time offset and wherein said transmitting a scheduling grant further comprises transmitting said scheduling grant to said second node.

3. The method as in claim 2, wherein said configuring said UE with a configurable time offset and said configuring said second node with said configurable time offset, is carried out by including said configurable time offset in said scheduling grant.

4. The method as in claim 1, wherein said configuring further comprises configuring said second node with said configurable time offset and further comprising sending said scheduling grant to said second node over a backhaul link.

5. The method as in claim 1, wherein said configurable time offset is not included in said scheduling grant and said configuring includes said UE configured with said configurable time offset during a plurality of subsequent scheduling grants.

6. The method as in claim 5, further comprising reconfiguring said UE with a different configurable time offset after said plurality of subsequent scheduling grants.

7. The method as in claim 1, further comprising determining said configurable time offset by estimating a latency of a backhaul used to communicate said scheduling grant.

8. The method as in claim 7, wherein said determining said configurable time offset further comprises estimating a time required to decode said scheduling grant and prepare for said UE transmitting or receiving a communication.

9. The method as in claim 1, wherein said configurable time offset includes an estimate of a latency of a backhaul used to communicate said scheduling grant and an estimate of a time required to decode said scheduling grant and prepare for said UE transmitting or receiving a communication.

10. The method as in claim 1, further comprising sending said scheduling grant to said second node and configuring said second node with said configurable time offset.

11. The method as in claim 1, wherein said transmitting a scheduling grant includes an associated regular start time of said communication and said configuring postpones said UE transmitting or receiving said communication, from said regular start time.

12. The method as in claim 1, wherein said wireless communication system comprises a Frequency Division Duplex (FDD) wireless communication system and said communication is an UL or a DL communication.

13. The method as in claim 1, wherein said configurable time offset comprises an integer representing a plurality of subframes.

14. The method as in claim 1, wherein said configurable time offset is an integer number of transmission time intervals (TTIs), slots, frames or symbols.

15. The method as in claim 1, wherein said configurable time offset comprises a plurality of orthogonal frequency division multiplexing (OFDM) symbols.

16. The method as in claim 1, wherein a regular start time of a scheduled DL communication based on said transmitting a scheduling grant is postponed an integer number of OFDM symbols by said configurable time offset.

17. The method as in claim 1, wherein said scheduling grant is a downlink (DL) grant that informs said UE that said UE is to receive a DL data transmission.

18. The method as in claim 1, wherein said communication is an uplink (UL) communication or a downlink (DL) communication.

19. The method as in claim 1, wherein said transmitting a scheduling grant and said UE transmitting or receiving a communication take place using the same carrier and further comprising configuring said second node with said configurable time offset.

20. The method as in claim 1, wherein said transmitting a scheduling grant and said UE transmitting or receiving a communication take place using different carriers.

21. The method as in claim 20, wherein said different carriers comprise Time Division Duplex (TDD) carriers.

22. The method as in claim 19, wherein said second node requests said first node to use a specific offset or a range of additional offsets, between said transmitting a scheduling grant and said UE transmitting or receiving a communication scheduled by said scheduling grant.

23. The method as in claim 1, wherein said configuring is carried out using radio resource control (RRC) signaling.

24. The method as in claim 1, wherein said configuring comprises transmitting said configurable time offset in a Downlink Control Information (DCI).

25. The method as in claim 1, wherein said UE transmitting or receiving said communication is further delayed from said transmitting a scheduling grant, by a UL time advance.

26. The method as in claim 1, wherein said scheduling grant includes therein an UL index that identifies an UL subframe for said communication.

27. The method as in claim 1, further comprising transmitting a plurality of additional scheduling grants to a plurality of further UEs, wherein said additional scheduling grants schedule said further UEs for simultaneously transmitting or receiving corresponding communications with the same node, and wherein said configuring includes each of said plurality of UEs configured with said configurable time delay.

28. A method in a wireless communication system, said method comprising:
transmitting a scheduling grant to a User Equipment (UE);
configuring said UE with a configurable time offset; and
said UE transmitting or receiving a communication scheduled by said scheduling grant,
said UE transmitting or receiving said communication delayed from said transmitting a scheduling grant by at least said configurable time offset

29. A method in a wireless communication system, said method comprising:
transmitting a scheduling grant to a User Equipment (UE), said transmitting a scheduling grant scheduling a communication and including a regular start time associated with said communication;
configuring said UE with a configurable time offset; and
said UE transmitting or receiving said communication,
said UE transmitting or receiving said communication offset from said regular start time by at least said configurable time offset.

30. The method as in claim 29, wherein and said configuring causes said UE transmitting or receiving said communication, to take place before said regular start time.

31. A method in a wireless communication system, said method comprising:
transmitting a scheduling grant to a User Equipment (UE) and a node, said transmitting a scheduling grant scheduling a communication and including a regular start time associated with said communication;
configuring said UE and said node with a configurable time offset; and
said UE communicating with said node by transmitting or receiving said communication scheduled by said scheduling grant,
said UE communicating being offset from said regular start time by at least said configurable time offset.

32. The method as in claim 31, wherein said transmitting a scheduling grant is done by another node.

33. The method as in claim 31, wherein and said configuring causes said UE communicating with said node, to take place before said regular start time.

34. The method as in claim 31, wherein said transmitting a scheduling grant and said UE communicating, take place using different carriers.

35. The method as in claim 31, wherein said configurable time offset is an integer number of transmission time intervals (TTIs), slots, subframes, frames or symbols.

36. The method as in claim 31, further comprising determining said configurable time offset by estimating a latency of a backhaul used to communicate said scheduling grant and by estimating a time required to decode said scheduling grant and prepare for said UE transmitting or receiving a communication.

37. The method as in claim 31, further comprising sending said scheduling grant to said node over a backhaul link.

38. The method as in claim 31, wherein said configurable time offset is not included in said scheduling grant and said configuring includes said UE configured with said configurable time offset during a plurality of subsequent scheduling grants and further comprising reconfiguring said UE with a different configurable time offset after said plurality of subsequent scheduling grants.

39. A non-transitory computer readable storage medium comprising computer-executable program code, the program code when executed by a processor performing a method for wireless communication in a wireless communication system, said method comprising:
transmitting a scheduling grant to a User Equipment (UE);
configuring said UE with a configurable time offset; and
said UE transmitting or receiving a communication scheduled by said scheduling grant,
said UE transmitting or receiving said communication delayed from said transmitting a scheduling grant by at least said configurable time offset.

40. The non-transitory computer readable storage medium as in claim 39, wherein said method further comprises said configuring further comprising configuring a node with which said UE transmits or receives said communication, with said configurable time offset and further comprising transmitting said scheduling grant to said node.

41. The non-transitory computer readable storage medium as in claim 39, wherein said wireless communication system is a long-term evolution (LTE) wireless communication system, said configurable time offset is an integer number of a plurality of orthogonal frequency division multiplexing (OFDM) symbols and a regular start time of a scheduled DL communication associated with said transmitting a scheduling grant, is postponed by said integer number of a plurality of OFDM symbols.

42. The non-transitory computer readable storage medium as in claim 39, wherein said configurable time offset is an integer number of transmission time intervals (TTIs), slots, subframes, frames or symbols.

43. The non-transitory computer readable storage medium as in claim 39, wherein said method further comprises said determining said configurable time offset by estimating a latency of a backhaul used to communicate said scheduling grant and estimating a time required to decode said scheduling grant and prepare for said UE transmitting or receiving a communication.

44. The non-transitory computer readable storage medium as in claim 39, wherein said configurable time offset comprises an integer representing a plurality of subframes or a plurality of orthogonal frequency division multiplexing (OFDM) symbols.

45. The non-transitory computer readable storage medium as in claim 39, wherein said method includes said configuring said UE with a configurable time offset being carried out by including said configurable time offset in said scheduling grant.

46. The non-transitory computer readable storage medium as in claim 39, wherein said wireless communication system is a cross-node system, said transmitting a scheduling grant is carried out by a first node, said UE transmitting or receiving a communication comprises said communication being with a second node, said first and second nodes being different nodes and wherein said method further comprises transmitting said scheduling grant to said second node and configuring said second node with said configurable time offset.

47. The non-transitory computer readable storage medium as in claim 39, wherein said UE transmitting or receiving a communication is further delayed from said transmitting said scheduling grant, by a fixed time delay or an UL time advance and said scheduling grant includes therein an UL index that identifies an UL subframe for said communication.

48. The non-transitory computer readable storage medium as in claim 39, wherein said method includes said configuring being carried out using radio resource control (RRC) signaling or by including said configurable time offset in a Downlink Control Information (DCI).

49. The non-transitory computer readable storage medium as in claim 39, wherein said wireless communication system is a cross-node Time Division Duplex (TDD) system, said transmitting a scheduling grant is carried out by a first node, said UE transmitting or receiving a communication comprises said communication being with a second node, said first and second nodes being different nodes, and said transmitting a scheduling grant and said UE transmitting or receiving a communication take place using the same carrier.

50. The non-transitory computer readable storage medium as in claim 39, wherein said transmitting a scheduling grant includes an associated regular start time of said scheduled communication and said configuring postpones said UE transmitting or receiving a communication, from said regular start time.

51. A wireless communication system comprising:
a node configured to transmit a scheduling grant to a User Equipment (UE) and configure said UE with a configurable time offset; and
said UE configured to transmit or receive a communication scheduled by said scheduling grant, after a time delay determined at least by said configurable time offset.

52. The wireless communication system as in claim 51, wherein said UE is configured to transmit or receive said communication with a further node and said node is further configured to send said scheduling grant to said further node and to configure said further node with said configurable time offset.

53. The wireless communication system as in claim 51, wherein said node is configured to include said configurable time offset in said scheduling grant.

54. The wireless communication system as in claim 51, wherein said configurable time offset comprises an integer representing a number of transmission time intervals (TTIs), slots, subframes, frames or symbols.

55. The wireless communication system as in claim 51, wherein said configurable time offset comprises a plurality of orthogonal frequency division multiplexing (OFDM) symbols.

56. The wireless communication system as in claim 51, wherein said wireless communication system is a cross-node system and said UE is configured to transmit or receive said communication with a further node.

57. The wireless communication system as in claim 56, wherein said wireless communication system is a cross-carrier scheduling system.

58. The wireless communication system as in claim 56, wherein said node is configured to transmit a scheduling grant and configure said UE, and said UE is configured to transmit or receive said communication, on the same carrier.

59. The wireless communication system as in claim 51, wherein said time delay comprises said configurable time offset and at least one of a fixed time delay and an UL time advance, and wherein said node is further configured to include an UL index in said scheduling grant.

60. The wireless communication system as in claim 51, wherein said time delay comprises said configurable time offset.

61. A wireless communication system comprising:
a node configured to transmit a scheduling grant to a User Equipment (UE) and a further node;
at least one of said node and said further node configured to configure said UE with a configurable time offset; and
said UE configured to transmit or receive a communication scheduled by said scheduling grant, with said further node, after a time delay determined at least by said configurable time offset.
